(19) United States
(12) Patent Application Publication
(10) Pub. No.: US 2015/0374096 A1
(43) Pub. Date: Dec. 31, 2015

(54) MOBILE POWER PACK WITH COSMETICS-HEATING FUNCTION

(71) Applicant: Powergene Technology Co., Ltd., Taiwan Branch, New Taipei City (TW)

(72) Inventor: Hui-Te HSU, New Taipei City (TW)

(21) Appl. No.: 14/315,533

(22) Filed: Jun. 26, 2014

(51) Int. Cl. A45D 33/26; H05B 3/02

(52) U.S. Cl. CPC A45D 33/26; H05B 3/02

(57) ABSTRACT

The present invention provides a mobile power pack with cosmetics-heating function. The housing has formed an accommodating space for accommodating cosmetics, and the power module is disposed in the housing. The heating element is disposed in the housing corresponding to the accommodating space. The heating element is electrically connected with the power module, and the cover combines together with the housing for covering the accommodating space.

### BACKGROUND OF THE INVENTION

1. Field of the Invention

The present invention generally relates to a mobile power pack and, in particular to a mobile power pack with cosmetics-heating function.

2. Description of Prior Art

With the popularity of wireless communications and wireless networks, the frequency of using smart mobile devices is increased in daily life; however, the consumption of electric power will be increased also. For this reason, most people carry a mobile power pack for charging mobile device at anytime, in anywhere. A mobile power pack is a kind of portable charger of power supply and charging. Generally speaking, a mobile power pack has s lithium battery core as a power storage unit because it has characteristics of high capacity, multi-purpose, small size, long life, safe and reliability.

On the other hand, in cold areas, especially where it snows often, powdery cosmetics in low temperature environment usually gets solid and unable to use, which will cause great inconvenience for users. Therefore, how to use a portable mobile power pack for heating cosmetics is a motivation of the present invention.

In view of the above drawbacks, the Inventor proposes the present invention based on his expert knowledge and elaborate researches in order to solve the problems of prior art.

### SUMMARY OF THE INVENTION

Accordingly, an object of the present invention is to provide a mobile power pack, which combines the portable mobile power pack with cosmetics for making use of the mobile power pack to heat the cosmetics.

In order to achieve the object mentioned above, the present invention provides a mobile power pack with a cosmetics-heating function. The mobile power pack includes a housing having an outer surface, and the outer surface has formed an accommodating space for accommodating cosmetics. A power module is installed in the housing. A heating element is disposed in the housing corresponding to the accommodating space and electrically connected with the power module. And a cover is combined together with the housing for covering the accommodating space.

Another object of the present invention is to provide a mobile power pack, which includes a heating switch and a button for operating the mobile power pack to heat the cosmetics.

Comparing to the prior art, the mobile power pack of the present invention can put cosmetics in the housing, and a heating element is disposed for heating the cosmetics. When the cosmetics get solid because of low temperature, users can heat the cosmetics through the mobile power pack of the present invention.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective explosion schematic view of mobile power pack of the present invention;

FIG. 2 is a perspective schematic view of mobile power pack of the present invention;

FIG. 3 is an assembly cross sectional view of mobile power pack of the present invention

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

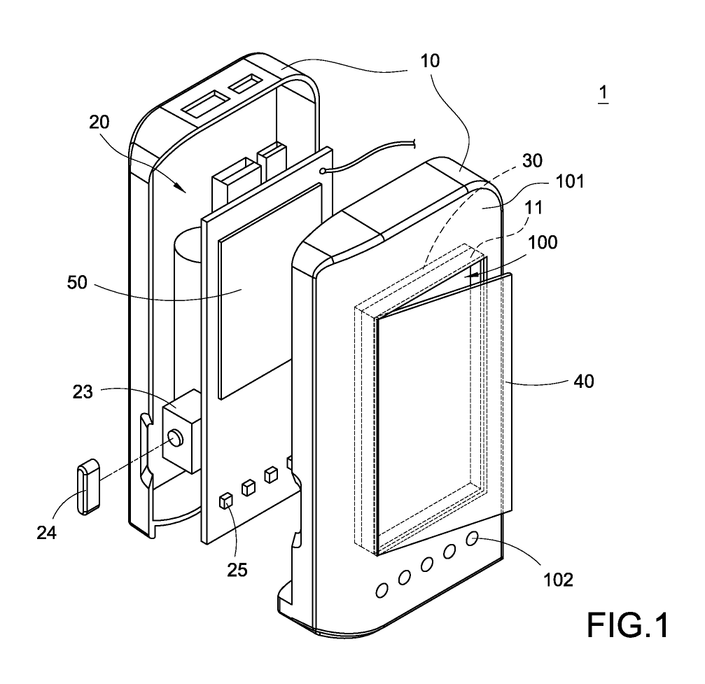

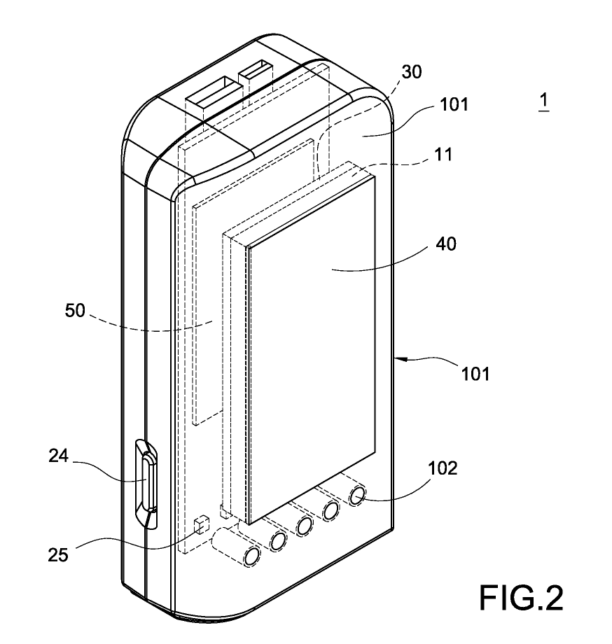

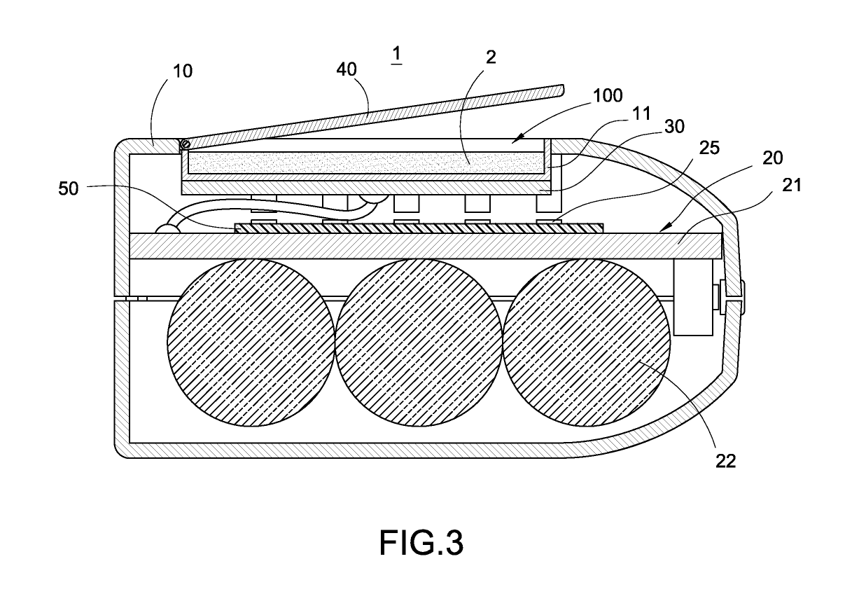

Please refer to FIG. 1 to FIG. 3, they depict a perspective explosion schematic view and a perspective schematic view and an assembly cross sectional view of mobile power pack of the present invention. A mobile power pack 1 of the present invention is particularly suitable for using in a low temperature environment, such as an area which snows frequently. The mobile power pack 1 includes a housing 10, a power module 20, a heating element 30 and a cover 40. The power module 20 and the heating element 30 are disposed in the housing 10, and the power module 20 provides electricity for the heating element 30 of generating heat. The cosmetics 2 can be heated by the heating element 30 for using.

The housing 10 has an outer surface 101, and the outer surface 101 has formed an accommodating space 100 for accommodating a cosmetic 2. In the present invention, the housing 10 further includes a carrier frame 11. The carrier frame 11 is disposed in the accommodating space 100, and the cosmetic 2 is placed in the carrier frame 11.

The power module 20 is installed in the housing 10. In an embodiment of the present invention, the power module 20 includes a circuit board 21 and at least one rechargeable battery 22 electrically connected with the circuit board 21, wherein the rechargeable battery 22 is, but not limited to, an lithium battery for recharging.

Moreover, the heating element 30 is electrically connected with the circuit board 21 of the power module 20 and disposed in the housing 10 corresponding to the accommodating space 100. Besides, the heating element 30 can be, but not limited to, a mica electric heating plate or a ceramic heater. Preferably, the heating element 30 is located in a bottom out of the accommodating space 100 (carrier frame 11) for heating the cosmetics 2 provided in the accommodating space 100.

The cover 40 combines together with the housing 10 for covering the accommodating space 100. In an embodiment of the present invention, one side of the cover 40 is pivoted on the housing 10 and is rotatable with respect to the housing 10. Thus the cosmetic 2 provided in the accommodating space 100 will be protected under the cover 40 without dropping, and damages will be avoided from an impact of other objects.

When surrounding is at a low temperature, the cosmetics 2 usually get solid and become difficult to use. At this time, we can use the mobile power pack 1 of the present invention to heat the cosmetics 2. After heating, the cosmetics 2 will be easily to put on skins for using. Furthermore, the cosmetics 2 could be replaced base on personal like, such as eye shadows, powders or other makeup products.

In an embodiment of the present invention, preferably, the carrier frame 11 is a thermal conductive metal frame. The heating element 30 contacts the carrier frame 11 in a side toward the power module 20, and then the heat of the heating element 30 can be transferred to the carrier frame 11 evenly. Moreover, the power module 20 further includes a heating switch 23 electrically connected with the circuit board 21 and a button 24 is operable to press against the heating switch 23. The button 24 is partially exposed out of the housing 10. In addition, the power module 20 includes at least one LED (light emitting diode) 25 electrically connected with the circuit board 21, and the housing 10 has at least one aperture 102 corresponding to the position of the LED 25. In the embodiment of the present invention, the LED 25 is exposed out of the aperture 102.

It is worth of notice that the mobile power pack 1 further includes a heat insulation film 50, wherein the heat insulation film 50 is disposed between the heating element 30 and the power module 20. The heat insulation film 50 is provided to prevent the heating element 30 from heating the power module 20 (circuit board 21) when the heating element 30 heating the cosmetics 2. Therefore, the damages of the power module 20 because of high temperature will be avoided.

The mobile power pack 1 of the present invention can be placed in the accommodating space 100. To use the cosmetics 2, the heating switch 23 will be turned on after pushing the button 24. At last, the heating element 30 will start to heat, and the heated cosmetics 2 will be easily to put on skins.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A mobile power pack with cosmetics-heating function, comprising:
a housing having an outer surface, and the outer surface formed an accommodating space for accommodating cosmetics;
a power module installed in the housing;
a heating element disposed in the housing corresponding to the accommodating space and the heating element electrically connected with the power module; and
a cover combining with the housing for covering the accommodating space.

2. The mobile power pack according to claim 1, wherein the housing further includes a carrier frame, the carrier frame is disposed in the accommodating space, and the cosmetics are placed in the carrier frame.

3. The mobile power pack according to claim 2, wherein the carrier frame is a metal frame and the heating element contacts the carrier frame in a side toward the power module.

4. The mobile power pack according to claim 2, wherein one side of the cover is pivoted on the housing and is rotatable with respect to the housing.

5. The mobile power pack according to claim 1, further including a heat insulation film, wherein the heat insulation film is disposed between the heating element and the power module.

6. The mobile power pack according to claim 1, wherein the power module includes a circuit board and at least one rechargeable battery electrically connected with the circuit board, and the heating element is electrically connected with the magnetic induction switch.

7. The mobile power pack according to claim 6, wherein the power module further includes a heating switch electrically connected with the circuit board and a button being operable to press against the heating switch, and the button is partially exposed out of the housing.

8. The mobile power pack according to claim 7, wherein the power module further includes at least one LED (light emitting diode) electrically connected with the circuit board, the housing has at least one aperture corresponding to the position of the LED, and the LED is exposed out of the aperture.
